(19) United States
(12) Patent Application Publication
(10) Pub. No.: US 2003/0213122 A1
(43) Pub. Date: Nov. 20, 2003

(54) Polymer/metal composite load cell

(76) Inventor: Kent Koh, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/144,700

(22) Filed: May 15, 2002

(51) Int. Cl. H01C 17/28; H01H 1/00; H01R 43/00

(52) U.S. Cl. 29/825; 29/621.1; 29/593

(57) ABSTRACT

A load cell is made by polymer/metal composite materials or pure polymer with two or more flexible arms to transmit loading and four or times of four strain gages to transfer mechanical strain into electrical signal. The structure of load cell can be standed various direction and various position of loading. With dramatically reduction in manufacturing step, the processing time can be correspondently shortened. This gives flexibility in manufacturing.

### BACKGROUND OF THE INVENTION

1. Field of Invention

The invention presents a new method of producing force transducers, especially in the manufacturing processes by adopting polymer composite materials.

2. Description of the Prior Art

The tradictional spring elements of load cells are machined by a bulk of metal. The shortcoming includs the large loss of materials due to machining, longer machining time and the instabililty of end products due to complex machining processes. For typical laod cell applications, the linearity precision is mostly higher than 2,000 divisons, thus small machining deviation can destroy the preset precisions. Tradional machining methods require 15 to 20 times maching processes and it is easy to accumulate machining errors to degrade the precision achievment.

The invention here presents a new method of forming the spring elements without the shortcomings mentioned above by the tradictional method.

### SUMMARY OF THE INVENTION

The invention presented here included the following features,

1. One kind of non-tranditional metallic equipment or load cell, as depicted in FIG. 1, that transfers weight or force into electrical signal consists of:

A Wheatstone bridge as shown in FIG. 2 that includes one set of two or more strain gages made by metal, resistor(s) used to zero adjustment, resistor(s) used to temperature compensation, floppy circuit board used to signal transmission, glue used to protect circuit, blank to carry loading or force, and cable to transmit signal to indicator.

2. Blank in 1 of FIG. 1 is completely made by polymer composite, sensing part by metal and supporting part by polymer composite, or sensing part by polymer composite and supporting part by metal embedding in polymer composite.

3. The thermal coefficient of expansion (CTE) of blank in 1 of FIG. 1 is set to be 5˜30 PPM/° C.

4. Composite in 1-1 of FIG. 1 is made by reinforcement of chopped fibers, whisker, non-woven fabrics, prepreg fabrics that are metal, ceramics, or polymer.

### BRIEF DESCRIPTION OF THE FIGURES

The figures disclosed an illustrative embodiment of the present invention which serves to exemplify the various advantages and objects hereof, and are as follows;

FIG. 1 Constructions of the Polymer/Metal Composite Load Cell claimed in this invention;

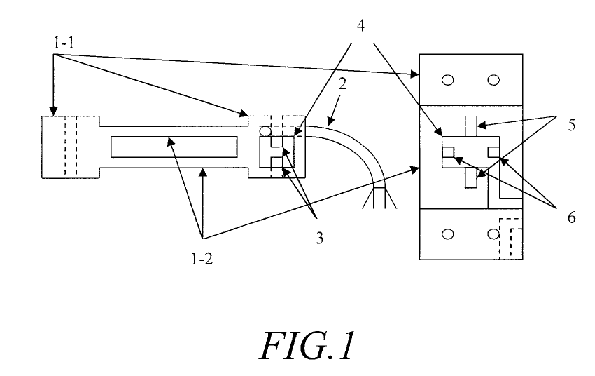

FIG. 2 Wheatstone bridge circuit used in the load cell;

FIG. 3 Typical configuration of a load cell deformed under applied load;

FIG. 4 Possible combinations of metal beams and polymer blank;

FIG. 5 Traditional manufacturing flow of Load cell;

FIG. 6 Manufacturing procedure of composite load cells;

FIG. 7 Manufacturing flow for pure composite load cell.

### BACKGROUND

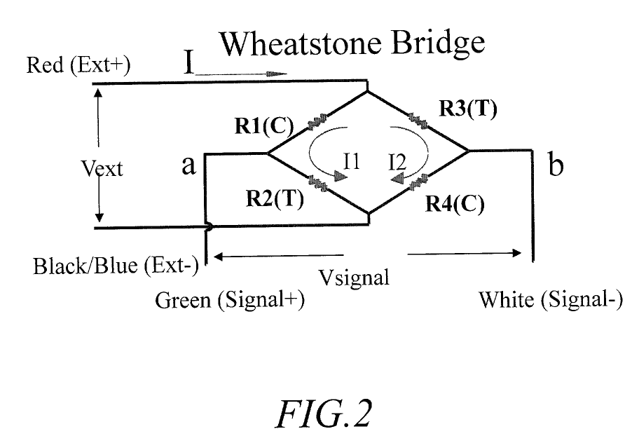

The load cell in this patent is a kind of transducer used in weighing or force measurement. It is different from accelerator made by techniques used in semiconductor integrated circuit. A load cell composes of four or times of four resistor-like sensing elements so called strain gage. Those strain gages are arranged as a Wheatstone bridge as shown in FIG. 2 that can be detected the miniature difference in deformation on each strain gage carried by blank. This deformation of each strain gage changes the resistance of strain gage correspondently. The resistance change of each strain gage is proportional to the deformation in each strain gage. Therefore, we can use this phenomenon to measure the force or weight.

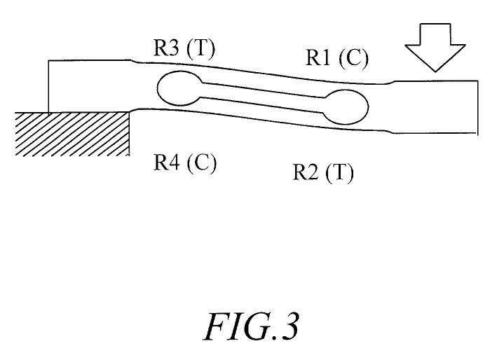

Blank is a major component in a load cell as referred to FIG. 3. It works as a spring. In accordance with Hook's law, the blank deforms when loaded by force or weight and it recovers to its original state after this load removing.

The main difference of load cell in this case is the materials blank used. Tranditionally, men make load cell by metal as a blank, but we hereby use composite rather than pure metal as a blank. The composite here consists of partly polymer and partly metal or purely polymer.

To make a blank by metal, it usually starts by a whole metal block. Therefore, the performance of load cell is partly controlled by blank's precision. Furthurmore, the dimension of blank is affected by the sum of every tolerance in machining. The general precision of a load cell made by metal will be 0.0005 to 0.00007 and it will be affected by the miniature difference in machining. On the other hand, the precision of load cell made by composite is only controlled by the precision of molder, so it can be increased up to 0.00003 or higher.

### DETAILED DESCRIPTION OF THE PREFERRED EMBODIMENT

Compared to the composite load cell made by molding, the yield for the machining of tranditional metal load cells is pretty low and the processing time is quite long, so the whole manufacturing procedure is very tedious and unstable.

The basic principle of laod cell working can be expressed as: According to Ohm's law, V=IR, then we can have, I=V/R. In Wheatstone bridge,

I₁=Vₑₓₜ/(R₁+R₂),

I₂=Vₑₓₜ/(R₃+R₄)

So, Va=I₁R₂=VₑₓₜR₂/(R₁+R₂)

Also, Vb=I₂R₄=VₑₓₜR₄/(R₃+R₄)

$$\begin{matrix}Then , {V}_{signal} = Va - Vb \\ = {V}_{ext} {R}_{2} / ( {R}_{1} + {R}_{2} ) - {V}_{ext} {R}_{4} / ( {R}_{3} + {R}_{4} ) \\ = {V}_{ext} ( {R}_{2} / ( {R}_{1} + {R}_{2} ) - {R}_{4} / ( {R}_{3} + {R}_{4} ) )\end{matrix}$$

Finally, V_{signal}Nₑₓₜ=(R₂/(R₁+R₂)−R₄/(R₃+R₄))=O/P

Vsignal is a definite factor to improve the precision of load cell under the condition that Vext is provided by system and is stationary from the equation above. From the basic theory of laod cell, Vsignal has a relationship with the resistance change of each strain gage in Wheatstone bridge as:

$$\frac{Δ R}{R} = K \frac{Δ l}{l} = K ϵ$$

Where ε is the strain in blank and proportional constant K is a gage factor. In the later equation, P is the applying force or loading, E is Young's modulus of blank which is a materials related property, and A is the cross-section area of blank which is related to blank design. In case of the same strain, the greater the gage factor, the more output of the load cell. Yet, the greater the strain, the better for the load cell application.

Although the basic principle of load cell was explained above, there is a restriction: load cell cannot work over its elastic limit, that is, plastic deformation is unallowable. Basically, the elastic limit of a metallic load cell will be within 0.2% of its expansion limit. However, the normal usable elastic limit will be around 0.1% to keep the possible safety factor. Under this circumstance, the available usable elastic limit of a metallic load cell is far less than that of a composite load cell. For a metal/polymer composite load cell, the available usable elastic limit is more than 1% and the utimate expansion limit can be above 5%. Therefore, the precision of composite load cell can be 10 times higher than that of metallic load cell.

Load cell will suffer force or weight more than its rated loading in any application. At this moment, composite blank in load cell can work well under 1.5˜2 times of its static rated loading or instant loading which is tens of times of static loading.

Compared to polymer, metal has advantages below: adequate strength and toughness, excellant thermal and electric conductivity, wider usable temperature range, good fatigue and creep resistance, moderate tribological resistance, and easier machining. On the other hand, metal has shortcomes as: higher density, poor corrosive and weather resistance, low electrical insulatence, difficultly structure design, and higher cost. Some shortcomings of metals cannot be overcame for a long time especially used in load cell as: higher density, poor corrosive and weather resistance, and low electrical insulatence. Therefore, we try to use composite materials to take over metal in load cell. The composite materials can have advantages and it can avoid some shortcomings in both metal and polymer.

Although composite materials have advantages above, it is also very important to consider the mismatch of thermal coefficient between reinforcements and matrix used in blank. The major function of blank in load cell is to transfer loading to Wheatstone bridge made by strain gage completely and quickly. Once the mismatch between thermal coefficient of expansion in reinforcement and that in matrix happened, it will retard this transferring to Wheatstone bridge. Therefore, thermal coefficient of expansion for composite used in load cell is a very important index. To be used conveniently, we set up it within 5˜30 PPM/° C.

To support or carry loading applying to polymer/metal load cell, it may embed metallic parts into polymer by beam or frame-inserting type. In single-ended beam structure load cell, momentum balance becomes very important due to the application position of loading. The position of laoding is not always applied in ended surface of load cell. It is sporadically applied to any position between stationary surface and weighing surface. Therefore, the distribution of loading in blank depands upon the true dimension of blank and the position of loading applying. However, the uniformity of blank's dimension is not so good as theorical design in mass-production, so it has to be compensated by structure design.

From mechanics,

M (Moment)=F (Force)×S (Distance between pendulum and position of force applying).

The farther the distance between pendulum and position of force applying or weighing, the greater the deformation. In the case of single-ended beam load cell, the position of strain gages in three-beam structure are loacated in the central line of load cell, so the sensitivity of this kind of load cell to rotating moment is better than that of two-beam load cell.

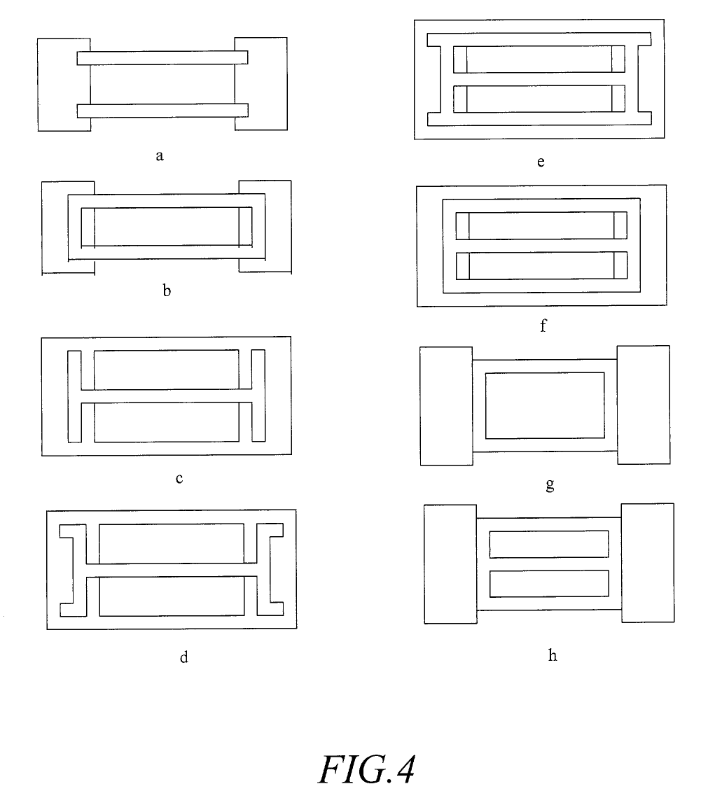

FIG. 4 provides the structures of possible combination of metal beams and polymer blocks. It may be different in pure polymer load cell.

To consider the safety in actual application of load cell, the strength of blank is set to 440 MPa or higher and the surface hardness of blank is required more than 75(HRB).

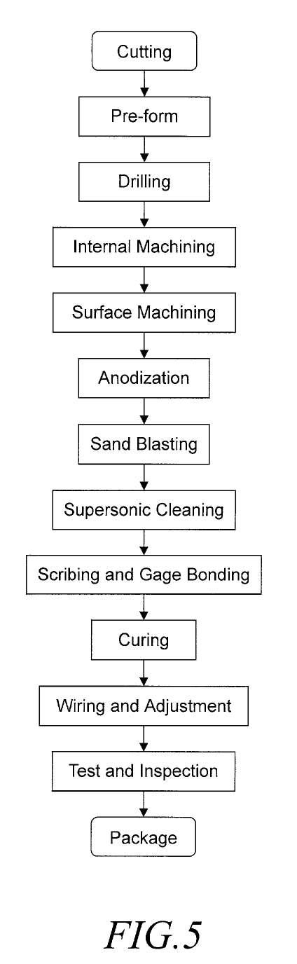

The manufacturing flow for a tranditional load cell is mainly expressed as in the FIG. 5.

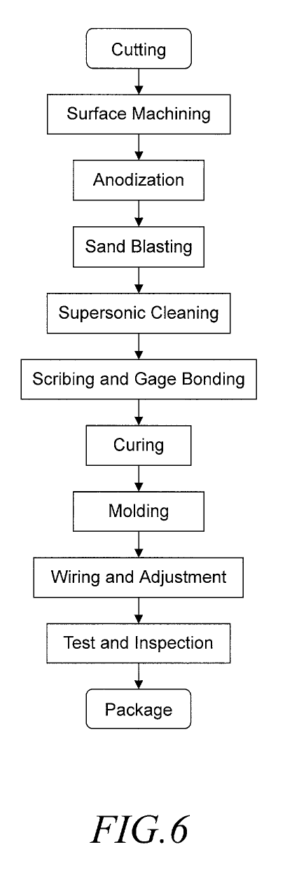

As stated above, a traditional load cell is machined several times. Each step accumulates deviation. The performance of load cell is affected by the final accumulated deviation. To improve the accumulated deviation, we use polymer/metal load cell instead. The manufacturing procedure of composite load cell is stated as in the FIG. 6.

In the manufacturing procedure above, the times of machining steps down, so the accumulated deviation is dramatically reduced. Under this circumstance, the final accumulated deviation at blank's dimension only depends upon merely the sum of deviation caused by machining and that of molder. Therefore, the performance of the final load cell can be more precise due to higher accuracy of blank.

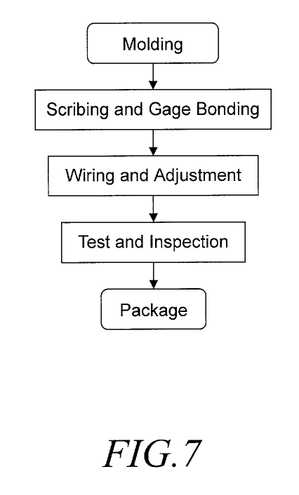

FIG. 7 presents the procedure of our manufacturing flow to pure composite load cell:

### References

U.S. Pat. No. 4,138,884 February/1979 Ruoff, Jr. . . . 73/133 R, 141A

U.S. Pat. No. 4,181,011 January/1980 Brendel . . . 73/141 A, 720, 726; 338/5

U.S. Pat. No. 4,196,784 April/1980 Suzuki . . . 177/211, 229, DIG. 9; 73/141 A

U.S. Pat. No. 4,259,863 April/1981 Rieck . . . 73/133 R, 141 A, 133 MC

U.S. Pat. No. 4,332,174 January/1982 Suzuki .........73/141 A, 726, 826.63; 73/862.65, 862.67; 177/211; 338/5

U.S. Pat. No. 4,343,197 August/1982 Suzuki . . . 73/744-777, 731768, 855, 862.85; 338/2,5

What is claimed is

1. A manufacturing process to make load cell including the following steps:
Step 1. Cutting
Step 2. Surface Machining
Step 3. Anodization
Step 4. Sand Blasting
Step 5. Ultrasonic Cleaning
Step 6. Scribing and Gage Bonding
Step 7. Curing
Step 8. Molding
Step 9. Wiring and Adjustment
Step 10. Test and Inspection
Step 11. Package
